(19) United States
(12) Patent Application Publication
(10) Pub. No.: US 2025/0246334 A1
(43) Pub. Date: Jul. 31, 2025

(54) Use of a Multi-Spectrum Microreactor to Produce Large Magnitude Out-Of-Core Thermal Neutron Fluxes Over Large Irradiation Volumes

(71) Applicant: NuScale Power, LLC, Corvallis, OR (US)

(72) Inventors: Frederick Botha, Corvallis, OR (US); Jackson Keppen, Corvallis, OR (US)

(21) Appl. No.: 19/039,486

(22) Filed: Jan. 28, 2025

Related U.S. Application Data
(60) Provisional application No. 63/625,553, filed on Jan. 26, 2024.

(51) Int. Cl. G21G 1/08; G21C 5/02; G21C 5/12; G21C 5/18; G21C 11/06

(52) U.S. Cl. CPC G21G 1/08; G21C 5/02; G21C 5/18; G21C 11/06; G21C 5/12

(57) ABSTRACT

A nuclear reactor is discussed herein. In some examples, the nuclear reactor may comprise an inner-core region, including liquid fuel, coolant/moderator, and a hydrogen vapor space, an out-of-core region surrounding the inner-core region, the out-of-core region including, an inner reflector adjacent to the inner-core region, the inner reflector including a first irradiation facility, and an outer reflector adjacent to the inner reflector, the outer reflector including a second irradiation facility.

### CROSS-REFERENCE TO RELATED APPLICATION(S)

This application claims the benefit of U.S. Provisional Patent Application No. 63/625,553, filed Jan. 29, 2024, and titled “USE OF A MULTI-SPECTRUM MICROREACTOR TO PRODUCE LARGE MAGNITUDE OUT-OF-CORE THERMAL NEUTRON FLUXES OVER LARGE IRRADIATION VOLUMES,” which is incorporated herein by reference in its entirety.

### BACKGROUND

There is a high demand for medicinal nuclear isotopes in the developed world, and the demand is growing year-over-year. A common way to produce these isotopes is within a nuclear fission reactor, usually a research reactor instead of an electricity-generating reactor. These reactors serve a vital role across many disciplines as being a safe and effective source of neutrons for research applications. The current fleet of high-flux US research reactors share several characteristics: water cooled reactors with solid fuel that requires frequent (every 1-10 weeks) shutdowns to swap and shuffle fuel, such as the Missouri University Research Reactor (MURR), the Advanced Test Reactor (ATR) and the High Flux Isotope Reactor (HFIR). These reactors are prized for their very large magnitude fluxes in their in-core flux traps, with thermal fluxes from 5×10¹⁴ to 2×10¹⁵ n/cm²-s. However, the volume of these irradiation facilities is limited due to the specialization of these reactors for in-core irradiation locations. The location of the flux traps also increases the impact of sample insertions into the core, reducing safety margins of the core and eliminating the ability to add and remove samples while the reactor is at full power. In order to insert or retrieve samples, the reactor must completely shut down. This reduces the capacity factor of the reactor, as well as limits sample irradiation times to exactly match the shutdown and startup schedule of the reactor. Given these constraints, more efficient generation of medial nuclear isotopes is necessary. Each of the references cited herein are incorporated by reference.

### BRIEF DESCRIPTION OF THE DRAWINGS

FIG. 1 illustrates a representative nuclear reactor according to an embodiment of this disclosure.

FIG. 2 illustrates a top-down view of a nuclear reactor, according to an embodiment of this disclosure.

FIG. 3 illustrates a top-down view of a nuclear reactor, according to an embodiment of this disclosure.

FIG. 4 illustrates a side cross-sectional view of a nuclear reactor, according to an embodiment of this disclosure.

FIG. 5 is a schematic view of a nuclear power plant system including multiple nuclear reactors in accordance with embodiments of the present technology.

### DETAILED DESCRIPTION

### Overview

The present technology is related to an advanced nuclear reactor. More specifically, the advanced nuclear reactor comprises a microreactor. In some embodiments, the microreactor may be a non-light water thermal reactor designed to be small and compact, highly reliable, fully automated, and rapidly deployed. In an embodiment, the electrical and thermal power output of a microreactor may range, according to end-use demand, from 2 to 10 Megawatts Electric (MWe) (8 to 40 Megawatt Thermal (MWth)). In an embodiment, the microreactor may use a liquid fuel (e.g., liquid uranium iron alloy (UFe), or any other suitable fuel) and a liquid metal alloy (e.g., calcium hydride, or any other suitable alloy) moderator-coolant. In an embodiment, the operation may occur at a high temperature and low pressure with heat transfer from the moderator coolant using heat pipes in the heat transfer system, radiator plates in the heat rejection system, and then to a final cooling system outside of the reactor system. This combination of fuel and coolant may facilitate low pressure, high temperature heat transfer and a simplified means for reactivity control. In an embodiment, an optimized neutron reflector and shielding region may be incorporated into the reactor design to meet safety and economic goals.

Specific details of several embodiments of the present technology are described herein. The present technology, however, may be practiced without some of these specific details. In some instances, well-known structures and techniques often associated with steam generation, nuclear power conversion systems, and the like have not been shown in detail so as not to obscure the present technology.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section. The headings provided herein are for convenience only and should not be construed as limiting the subject matter disclosed.

In an embodiment, the microreactor may be a 10s of megawatts thermal, variable neutron spectrum, compact microreactor that is capable of providing high thermal fluxes (i.e., greater than 5×10¹⁴ n/cm²-s) over large flux trap volumes (“flux traps”). These flux traps may be contained within the reflector of the microreactor, reducing the reactivity impact of sample insertion and removal as well as greatly increasing the available volume for irradiation. In an embodiment, the reduced reactivity effects of sample movement into and out of the flux traps may allow for on-line sample insertion and removal (i.e., sample removal while the reactor is operational and not shut down). In an embodiment, the microreactor may use a liquid fuel which allows for volatile fission products, including poisons (e.g., Xenon 135, etc.), to be removed from the fuel, which may increase the efficiency of the reactor and/or yield a longer operating life, simplify control of the reactor, and greatly reducing the fission products available to be released in the event of an accident, thus creating a stronger safety case.

In an embodiment, a microreactor may have a number of unique attributes that may follow a different design paradigm than the current high-flux research reactor fleet and result in a number of advantages. These advantages may include:
The use of a compact, multi-energy neutron spectrum reactor to generate a high neutron flux that is diffused into a reflector that thermalizes the neutrons into a high magnitude, low energy flux ideal for isotope production and many neutron-enabled research activities. The microreactor may take advantage of different neutron energy spectrums in different regions of the core, which may allow for low-energy (i.e., thermalized) regions to drive high-energy (i.e., fast) regions that may generate large magnitude localized fluxes that, in turn, drive high thermal fluxes in the flux traps outside of the reactor core.
Liquid fuel that may allow for higher axial power peaks without localized depletion, enabling operating cycles that are longer than a year, while maintaining higher overall fluxes.
Simplified reactivity control and larger safety margins due to liquid fuel. In an embodiment, the thermal expansion of the fuel may yield a strong negative relationship between temperature and power, allowing for power to be readily controlled by varying temperature and facilitating safer accident conditions by reducing power when temperature increases.
Lower enrichments in certain regions of the core that May 1) facilitate more efficient breeding, leading to longer lifetimes and more efficient use of the fuel, and 2) yield higher overall fluxes for the same power density.
Beryllium and/or beryllium oxide strategically placed in a fast flux region of the core and around the flux trap to maximize (n,2n) reactions (i.e., neutron capture reactions wherein a single high-energy neutron is captured by a large nucleus that subsequently releases two neutrons), resulting in higher localized fluxes around flux traps.
The use of magnesium compounds (e.g., magnesium oxide, magnesium hydroxide, etc.) as high temperature reflector and moderator materials. In embodiments, magnesium oxide may offer a low absorption and fast flux reflecting material. In embodiments, magnesium hydroxide may offer a high-temperature moderating and reflecting material.
A two-section reflector. In an embodiment, there may be one reflector (e.g., inner reflector, first reflector, etc.) placed immediately around the core to increase fuel efficiency by reflecting neutrons back into the core. In an embodiment, there may be a second reflector (e.g., outer reflector, etc.) placed outside of the reactor vessel whose purpose may be to thermalize neutrons and reflect neutrons back into the flux traps. The flux traps may be located within the outer reflector to allow for online access to samples within the flux traps. The outer reflector may also be a heterogenous combination of beryllium and magnesium compounds to take advantage of the properties listed in the paragraphs above. For example, in an embodiment, the outer reflector may include a first section (“inner section”) that includes beryllium and a second section (“outer section”) that includes magnesium compounds (e.g., magnesium oxide, magnesium hydroxide, etc.).

This Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

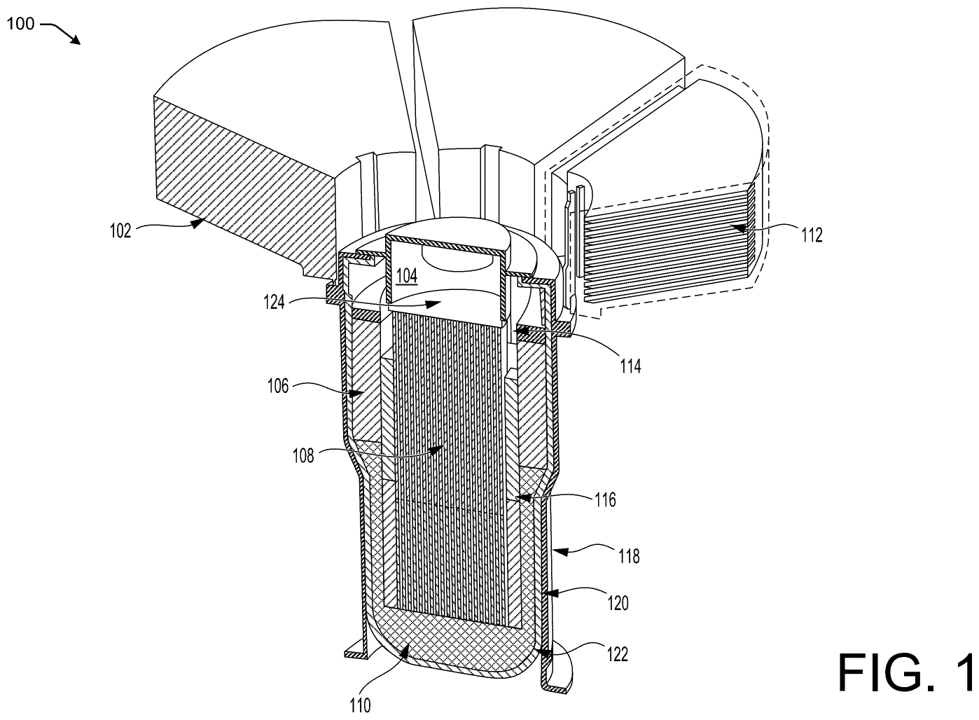

Specifically, FIG. 1 illustrates a representative nuclear reactor 100 (“reactor 100”) according to an embodiment of this disclosure. In an embodiment, the reactor 100 may include a casing 102, a fuel box 104, heat pipes 106, fuel tubes 108, a moderator/coolant 110, radiator plates 112, a hydrogen vapor space 114, a reflector region 116, a reactor container 118, insulation 120, reactor liner 122, and a fission product removal system 124. In an embodiment, the fission product removal system 124 may utilize the physical structure of the fuel box 104 as part of the fission product removal system 124. It is understood that the size and shape of a component within the reactor 100 may vary based on the particular application of the reactor 100. For example, it is understood that in an embodiment, the reactor 100 may be a microreactor that includes a larger reflector region 116 (relative to the reflector region 116 shown) that may be located outside or inside the reactor container and/or may include a smaller reactor core structure.

The reactor 100 may be a novel design that may deliver superior performance with high thermal neutron fluxes, large flux trap volumes, and simple operations that result in a reactor with no safety related systems. Varying hydrogen neutron moderation, through the reversible thermochemical reaction of hydrogen with liquid calcium dispersed in a liquid metal alloy, may provide a simple and reliable means of reactivity control. For example, in an embodiment, the reactor 100 may include a moderator/coolant 110 (e.g., calcium hydride, or other suitable alloy) and hydrogen gas within the hydrogen vapor space 114. The calcium within the moderator/coolant 110 may bond with the hydrogen such that the power of reactor 100 may be regulated using hydrogen rather than control rods.

Further, Xenon 135 (a neutron-absorbing fission product noble gas) may be released from the liquid UFe fuel and, as a result, reactivity may not need to be actively controlled during power maneuvering to account for xenon transients. For example, the liquid fuel within the reactor 100 may allow for fission products (including Xenon 135, which has a large cross section for neutron absorption) to be evaporated out of the fuel. As a result of the liquid fuel containing less neutron-absorbing fission products (e.g., Xe 135), the concentration of neutrons within the fuel increases, thereby yielding higher neutron fluxes throughout the core. In an embodiment, the reduction of Xe 135 concentration within the reactor 100 may reduce the necessity to compensate for a reduction in neutron fluxes throughout the core due to Xe 135 absorption (i.e., xenon transients). By eliminating the need for mechanical reactivity control systems (e.g., control drums and control rods) and xenon transients, the reactor design, reactor fabrication, and control system design may be simplified to improve overall reactor system reliability and allow cost competitiveness.

The fuel tubes 108 retain liquid UFe fuel and transfer heat to the moderator/coolant 110 flowing through the core. In an embodiment the fuel may include high enriched uranium (i.e., greater than or equal to 20% uranium). In an embodiment, the fuel may include low enriched uranium (LEU) (i.e., less than 20% uranium). The fuel tubes 108 may be open at a first end (e.g., top end) to direct volatile fission products and noble gases into a fission product removal system 124, thus eliminating the internal pressure load and need for thicker structural walls that may result from a build-up of fission gas.

The liquid moderator/coolant 110 may transfer heat from the fuel within the fuel tubes 108 to the heat pipes 106 through natural circulation. The liquid moderator/coolant 110 fills most of the internal free volume within the reactor container 118, with the exception of the hydrogen vapor space 114 at a top end of the reactor container 118 (which may be filled with hydrogen gas) and the fission product removal system 124, which may include a separate volume above the fuel to route fission product volatiles and gas. Hydrogen contained in the liquid moderator/coolant 110 may be regulated by adjusting the hydrogen pressure in the hydrogen vapor space 114 above the liquid moderator/coolant 110 surface. To achieve and maintain cold shutdown, hydrogen is removed from the reactor. In an embodiment, a hydrogen system (not shown) may provide for the addition and removal of the hydrogen gas within the hydrogen vapor space 114. Additional systems (not shown) supporting the operation of reactor 100 may include one or more of:
Auxiliary power system to support reactor components and systems requiring power (e.g., via advanced nuclear reactors, including small modular reactors and/or microreactors, conventional electrical systems, etc.);
control architecture to integrate all systems' instrumentation and control;
radioactive waste system for any additional radioactive management required outside of the fission product removal system; and
fuel handling system to support refueling.

The reactor 100 may be configured to provide the means needed for vital medical isotope productions and enable activities that are only possible with a powerful source of neutrons. In an embodiment, the reactor 100 may be used in irradiation facilities, such as high-flux irradiation locations, beam ports, and rapid-transfer pneumatically accessed irradiation locations (rabbits). The rabbit and beam port facilities may allow for university-lead initiatives over a wide spectrum of disciplines, such as short-lived isotope production for student labs, neutron activation analysis for archeology and anthropology, and neutron beams for diffraction and radiography studies. While the highest flux locations along the inner edge of the microreactor reflector may be primarily used for isotope production, the irradiation locations that line the outer edge of the outer reflector may still boast fluxes higher than 1×10¹⁴ n/cm²-s, which may allow for research experiments that do not require the highest magnitude fluxes.

### Isotope Production

In addition to a high flux and large volume, the ex-core location (i.e., location outside the core) of the flux traps may allow for on-line sample insertion and removal, giving the opportunity for optimum irradiation time for maximum isotope production. For example, because the reactor 100 may include flux traps outside the core, samples may be inserted and removed from sample locations without the need for shutting down the reactor 100.

In an embodiment, the high temperatures of the reactor 100 may allow for continuous, on-line extraction of fission gases from a liquid irradiation sample. In an embodiment, continuous on-line extraction of fission gasses may allow for immediate and continuous production of high-value medical isotopes with limited opportunity for produced isotopes to decay before extraction. Of particular note, a molten-chloride solution may form bonds with fission-produced molybdenum and escape the solution as a gas for collection.

### Vessel Type

The reactor 100 may include a reactor container 118 (i.e., vessel) may be a sealed, hydrogen containing reactor container 118 at low (e.g., less than 2 atmospheres) pressures. In an embodiment, access to the core may be possible during refueling outages, and access to irradiation facilities (i.e., sample locations) may be available at all times during operation.

Irradiation facilities may be operated at low temperatures with localized cooling, but bulk core temperature and moderator temperature may be high (i.e., greater than 850 degrees Celsius).

Reflector region 116 modularity may be possible with one or more core reflectors containing flux traps of a different size that may be exchanged during refueling outages, in order to accommodate different sized targets.

### Core Configuration

In an embodiment, the reactor 100 may not include primary cooling pumps and the reactor 100 may include only minimal in-core instrumentation. Specifically:
In an embodiment, in-core thermocouples may be minimized due to the high temperatures within the core.
In an embodiment, core power monitors may be contained outside of the core region to minimize the exposure to high temperatures. The out-of-core location of the core power monitors may allow them to be removed and maintained while the reactor 100 is on-line without opening the reactor container 118.
In an embodiment, one or more electromagnetic pump(s) (not shown) may be used to provide flow head to the moderator/coolant 110 to facilitate cooling at steady-state full power operations. In an embodiment, the electromagnetic pump(s) may operate without moving parts and without contacting the moderator/coolant 110.
In an embodiment, if an electromagnetic pump is required for steady state operations, it may hold no safety function and may contain no moving parts to require continuous maintenance.

### Reactor, Service, and Storage Pools

In an embodiment, the reactor 100 may reside within a reactor building (not shown). The reactor building may contain a reactor flow loop surrounded by a modular neutron reflector that contains the flux traps.

The reactor flow loop may contain the core while providing cooling. In an embodiment, there may be no safety-related systems in the reactor 100. Shielding may be provided by the reactor shield (not shown).

In an embodiment, isotope handling may occur outside of the reactor shield, with irradiation facility locations within the core reflector region 116.

In an embodiment, the reactor 100 may have as 24-month service interval, reducing the need for a dedicated service pool.

In an embodiment, the reactor 100 may have a one-month refueling cycle that may provide enough time for core decay power to drop below 50 kW, allowing for direct loading into advanced reactor fuel canisters.

In an embodiment, irradiation samples may pass through the core into shielded storage containers (not shown), which may be operable manually or remotely.

In an embodiment, on-line sample handling may be conducted at ex-core locations. In an embodiment, access to the flux traps may be achieved without opening a reactor coolant loop.

### Target Handling

In an embodiment, the reactor 100 may allow for automated sample loading through access ports at the top of the reactor, which may be available to use on-line. The reactivity impact of sample insertions may be mitigated since, in some embodiments, none of the flux traps may be located within the core itself. Samples may follow a once through path through the reflector region 116, with insertion occurring at the reactor top, and retrieval occurring beneath the reactor. Sample loading locations may be shielded by the reactor shield (not shown), and sample unloading positions may be shielded beneath the vessel. From here, samples may be moved through shielded casks (not shown) to one or more hot cell facilities (not shown).

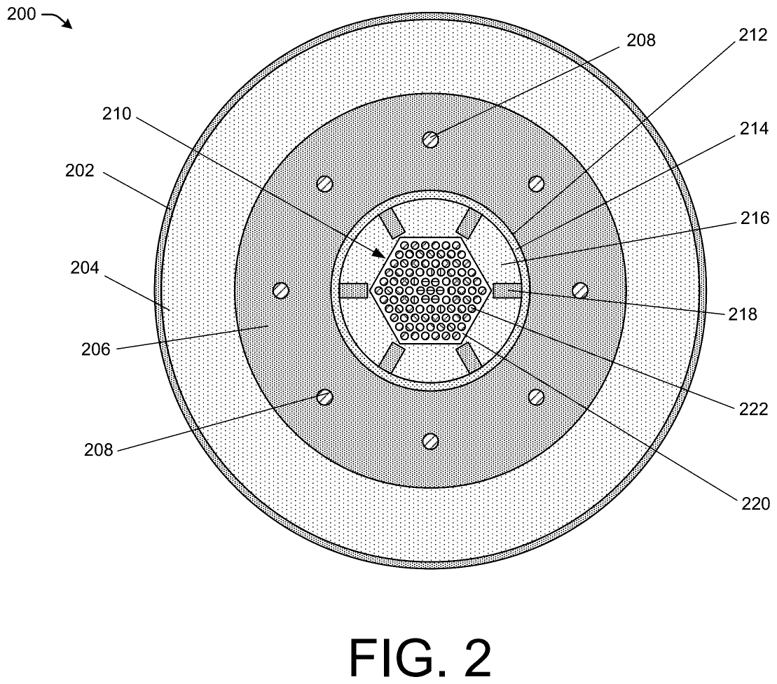

FIG. 2 illustrates a top-down view of a nuclear reactor 200 (“reactor 200”), according to an embodiment of this disclosure. In an embodiment, the reactor 200 may include a reflector container 202, an outer reflector 204, an inner reflector 206, an irradiation facility 208, and a reactor core 210. In an embodiment, the reactor core 210 may include a reactor container 212, insulation 214, an in-vessel reflector 216, moderator/coolant downcomer 218, moderator/coolant riser 220, and fuel 222.

In an embodiment, the fuel 222 within the reactor core 210 may be liquid (e.g., UFe, or any other suitable alloy). In an embodiment, the moderator/coolant downcomer 218 and the moderator/coolant riser 220 may be configured to allow a moderator/coolant (e.g., liquid calcium hydride alloy, or other suitable liquid alloy) to flow around the fuel 222 within the reactor core 210. For example, the moderator/coolant downcomer 218 may be configured to allow a moderator/coolant (e.g., the moderator/coolant 110, etc.) to flow from a bottom end of the reactor core 210 to a top end of the reactor core 210, while the moderator/coolant riser 220 may be configured to allow a moderator/coolant (e.g., the moderator/coolant 110, etc.) to flow from a top end of the reactor core 210 to a bottom end of the reactor core 210.

In an embodiment, the reflector container 202 may be configured to surround the outer reflector 204. In an embodiment, the outer reflector 204 may include magnesium (e.g., magnesium oxide, magnesium hydroxide, or other suitable material). The outer reflector 204 may be configured to reflect fast neutrons toward the reactor core 210.

In an embodiment, the reflector container 202 may include an inner reflector 206 that is disposed between the outer reflector 204 and the reactor core 210. In an embodiment, the inner reflector 206 may include an irradiation facility 208 (i.e., flux trap, etc.). It is understood that the reactor core 210 may include a single irradiation facility or multiple irradiation facilities. For example, as shown in FIG. 2, the reactor 200 may include multiple irradiation facilities (e.g., 2, 3, 4, . . . , 8, etc.). The irradiation facility 208 may be configured to receive sample insertions for irradiation (i.e., material to be irradiated to generate medical isotopes). In an embodiment, the inner reflector 206 may contain beryllium. The use of beryllium in the inner reflector 206 may contribute to increase (n,2n) reactions, thus a higher neutron flux. In an embodiment, the use of beryllium in the inner reflector 206 combined with the use of magnesium in the outer reflector 204 of reactor 200 may result in increased neutron fluxes at the irradiation facility 208, relative to a traditional reactor.

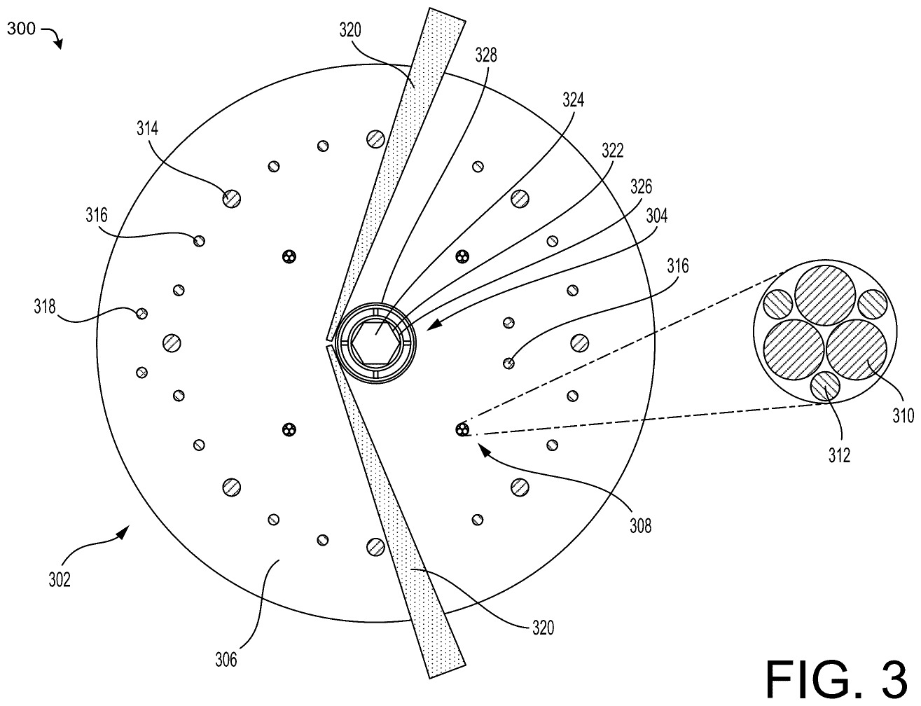

FIG. 3 illustrates a top-down view of a nuclear reactor 300 (“reactor 300”), according to an embodiment of this disclosure. In an embodiment, the reactor 300 may include an out-of-core region 302 and an inner-core region 304. In an embodiment, the out-of-core region 302 may include a reflector 306. In an embodiment, the reflector 306 may include a high flux irradiation region 308. The high flux irradiation region 308 may include a large diameter high flux irradiation facility 310 and a small diameter high flux irradiation facility 312. In an embodiment, the reflector 306 may also include a large diameter reflector irradiation facility 314, a small diameter reflector irradiation facility 316, a pneumatically accessed facility 318 (e.g., rapid-transfer pneumatically accessed irradiation location (“rabbit”)), and a thermal beam line 320 (e.g., beam port). It is understood that one or more components listed regarding reactor 300 may be identified as singular (i.e., a high flux irradiation region 308, a large diameter high flux irradiation facility 310, etc.), but may be referencing multiple instances. For example, as shown in FIG. 3, there are four high flux irradiation facilities, disposed within the reflector 306. In an embodiment, the in-core region 304 may include a moderator/coolant 322, fuel 324, insulation and reactor liner 326, and a reactor container 328.

In an embodiment, the reflector 306 may include a heterogenous combination of beryllium and magnesium compounds. In an embodiment, reactor 300 may be configured to only include irradiation facilities (“flux traps”) in the out-of-core region 302. It is understood that removing irradiation facilities from the in-core region 304 and disbursing the irradiation facilities to the out-of-core region 302 may result in the ability to optimize core design and operation. For example, the elimination of irradiation facilities in the in-core region 304 may allow the core to remain on-line while samples are inserted and/or removed from an irradiation facility, which may allow for increased sample irradiation.

In an embodiment, optimizing reactor core design and operation by relocating irradiation facilities to the out-of-core region 302 may result in an increase of core life. For example, a microreactor with an optimized core and optimized core operation (e.g., reactor 300) may have a core life of approximately 1-2 years, while a reactor having irradiation facilities within the core may have a core life of 1-6 weeks.

In an embodiment, relocating the irradiation facilities (e.g., the large diameter high flux irradiation facility 310, the small diameter high flux irradiation facility 312, the large diameter reflector irradiation facility 314, the small diameter reflector irradiation facility 316, etc.) from the inner-core region 304 to the out-of-core region 302 may increase the volume of irradiated material production since the area within the inner-core region 304 is more limited than the out-of-core region 302.

In an embodiment, the aggregate area of the irradiation facilities within the out-of-core region 302 may be larger than the sample area the inner-core region 304 may accommodate. Although the neutron flux may be higher in the inner-core region 304 relative to the out-of-core region 302, the benefit of the increased volume of simultaneous production may outweigh the potentially decreased neutron flux of the relocated irradiation facilities. For example, in an embodiment, the irradiation facilities within the out-of-core region 302 of the reactor 300 may be exposed to half the neutron flux as compared to the inner-core region 304 but may yield approximately 8 times the production rate.

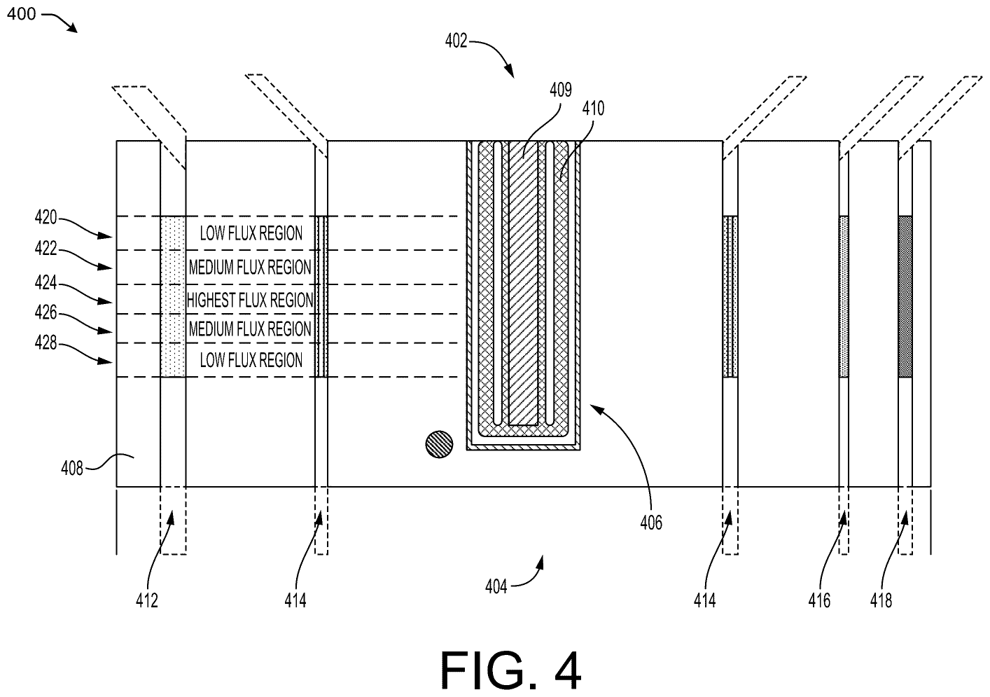

FIG. 4 illustrates a side cross-sectional view of a nuclear reactor 400 (“reactor 400”), according to an embodiment of this disclosure. In an embodiment, the reactor 400 may have a top end 402 and a bottom end 404 opposite the top end 402. In an embodiment, the reactor 400 may include an inner-core portion 406 and an out-of-core portion 408. In an embodiment, the inner-core portion 406 may include fuel 409 and a moderator/coolant 410. In an embodiment, the out-of-core portion 408 may include a large diameter reflector irradiation facility 412, a high flux irradiation region 414, a small diameter reflector irradiation facility 416, and a pneumatically accessed irradiation facility 418.

In an embodiment, a portion of the reactor 400 may be divided into a low flux region 420, a medium flux region 422, a highest flux region 424, a medium flux region 426, and a low flux region 428. The low flux region 420 may be more proximate to the top end 402 of the reactor 400 than the bottom end 404 of the reactor 400. The top end 402 of the medium flux region 422 may be adjacent to the low flux region 420 and the bottom end 404 of the medium flux region 422 may be adjacent to the highest flux region 424. In an embodiment, the bottom end 404 of the medium flux region 426 may be adjacent to the low flux region 428 and the top end 402 of the medium flux region 426 may be adjacent to the bottom end 404 of the highest flux region 424.

In an embodiment, the reactor 400 may include reflector and irradiation facility structures (not shown) that extend beyond the top end 402 and the bottom end 44 of the reactor 400.

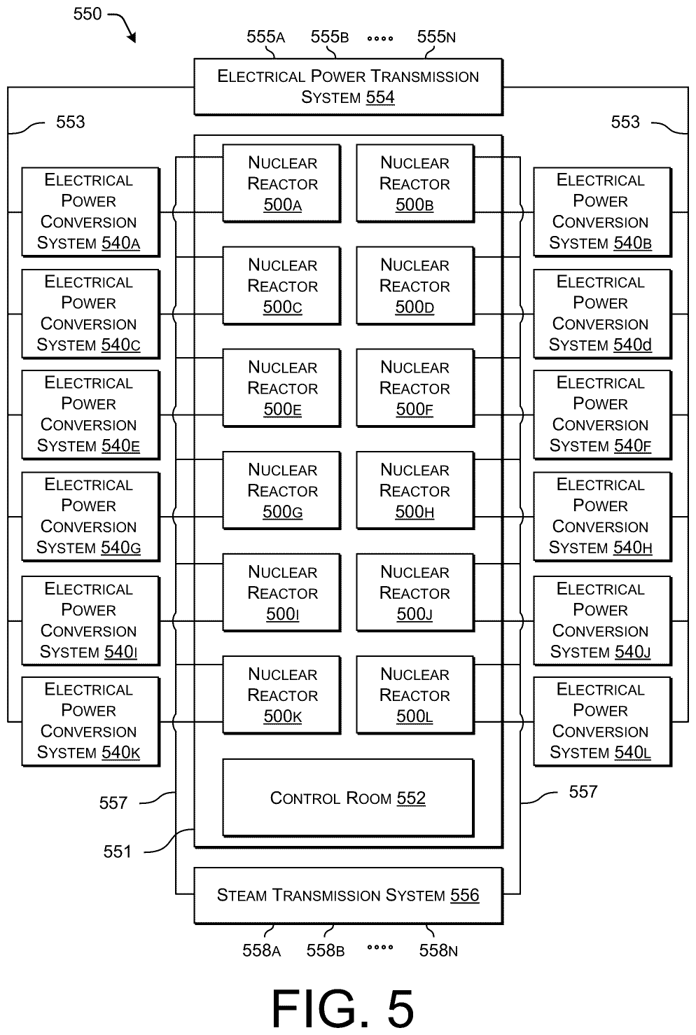

FIG. 5 is a schematic view of a nuclear power plant system 550 including multiple nuclear reactors 500 (individually identified as first through twelfth nuclear reactors 500a-1, respectively) in accordance with embodiments of the present technology. The power plant system 550 (“power plant system 550”) may be “modular” in that each of the nuclear reactors 500 may be operated separately to provide an output, such as electricity or steam. The power plant system 550 may include fewer than twelve of the nuclear reactors 500 (e.g., two, three, four, five, six, seven, eight, nine, ten, or eleven of the nuclear reactors 500), or more than twelve of the nuclear reactors 500. In an embodiment, all or part of the power plant system 550 may be a permanent installation or may be mobile (e.g., mounted on a truck, tractor, mobile platform, and/or the like). In the illustrated embodiment, each of the nuclear reactors 500 can be positioned within a common housing 551, such as a reactor plant building, and controlled and/or monitored via a control room 552.

Each of the nuclear reactors 500 can be coupled to a corresponding electrical power conversion system 540 (individually identified as first through twelfth electrical power conversion systems 540a-1, respectively). The electrical power conversion systems 540 can include one or more devices that generate electrical power or some other form of usable power from steam generated by the nuclear reactors 500. In some embodiments, multiple ones of the nuclear reactors 500 can be coupled to the same one of the electrical power conversion systems 540 and/or one or more of the nuclear reactors 500 can be coupled to multiple ones of the electrical power conversion systems 540 such that there is not a one-to-one correspondence between the nuclear reactors 500 and the electrical power conversion systems 540.

The electrical power conversion systems 540 can be further coupled to an electrical power transmission system 554 via, for example, an electrical power bus 553. The electrical power transmission system 554 and/or the electrical power bus 553 can include one or more transmission lines, transformers, and/or the like for regulating the current, voltage, and/or other characteristic(s) of the electricity generated by the electrical power conversion systems 540. The electrical power transmission system 554 can route electricity via a plurality of electrical output paths 555 (individually identified as electrical output paths 555a-n) to one or more end users and/or end uses, such as different electrical loads of an integrated energy system.

Each of the nuclear reactors 500 can further be coupled to a steam transmission system 556 via, for example, a steam bus 557. The steam bus 557 can route steam generated from the nuclear reactors 500 to the steam transmission system 556 which in tum can route the steam via a plurality of steam output paths 558 (individually identified as steam output paths 558a-n) to one or more end users and/or end uses, such as different steam inputs of an integrated energy system.

In some embodiments, the nuclear reactors 500 can be individually controlled (e.g., via the control room 552) to provide steam to the steam transmission system 556 and/or steam to the corresponding one of the electrical power conversion systems 540 to provide electricity to the electrical power transmission system 554. In some embodiments, the nuclear reactors 500 are configured to provide steam either to the steam bus 557 or to the corresponding one of the electrical power conversion systems 540 and can be rapidly and efficiently switched between providing steam to either. Accordingly, in some aspects of the present technology the nuclear reactors 500 can be modularly and flexibly controlled such that the power plant system 550 can provide differing levels/amounts of electricity via the electrical power transmission system 554 and/or steam via the steam transmission system 556. For example, where the power plant system 550 is used to provide electricity and steam to one or more industrial process-such as various components of the integrated energy systems, the nuclear reactors 500 can be controlled to meet the differing electricity and steam requirements of the industrial processes.

As one example, during a first operational state of an integrated energy system employing the power plant system 550, a first subset of the nuclear reactors 500 (e.g., the first through sixth nuclear reactors 500a-f) can be configured to provide steam to the steam transmission system 556 for use in the first operational state of the integrated energy system, while a second subset of the nuclear reactors 500 (e.g., the seventh through twelfth nuclear reactors 500g-1) can be configured to provide steam to the corresponding ones of the electrical power conversion systems 540 (e.g., the seventh through twelfth electrical power conversion systems 540g-1) to generate electricity for the first operational state of the integrated energy system. Then, during a second operational state of the integrated energy system when a different (e.g., greater or lesser) amount of steam and/or electricity is required, some or all the first subset of the nuclear reactors 500 can be switched to provide steam to the corresponding ones of the electrical power conversion systems 540 (e.g., the seventh through twelfth electrical power conversion systems 540g-1) and/or some or all of the second subset of the nuclear reactors 500 can be switched to provide steam to the steam transmission system 556 to vary the amount of steam and electricity produced to match the requirements/demands of the second operational state. Other variations of steam and electricity generation are possible based on the needs of the integrated energy system. That is, the nuclear reactors 500 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 500 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, although steps may be presented in a given order, in other embodiments, the steps may be performed in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A nuclear reactor, comprising:
an inner-core region including:
liquid fuel,
a moderator/coolant, and
a hydrogen vapor space; and
an out-of-core region surrounding the inner-core region, the out-of-core region including:
an inner reflector adjacent to the inner-core region, the inner reflector including a first irradiation facility, and
an outer reflector adjacent to the inner reflector, the outer reflector including a second irradiation facility.

2. The nuclear reactor according to claim 1, wherein the moderator/coolant includes calcium.

3. The nuclear reactor according to claim 2, wherein reactor power is regulated by a concentration of hydrogen within the hydrogen vapor space.

4. The nuclear reactor according to claim 1, wherein the inner reflector includes beryllium.

5. The nuclear reactor according to claim 1, wherein the outer reflector includes magnesium.

6. The nuclear reactor according to claim 1, wherein the liquid fuel includes uranium enriched below 20%.

7. The nuclear reactor according to claim 1, wherein the first irradiation facility includes a first flux trap and a second flux trap, wherein the first flux trap has a greater diameter than the second flux trap.

8. A nuclear reactor system, comprising:
a nuclear reactor, including:
an inner-core region configured to generate a neutron flux, and
an out-of-core region surrounding the inner-core region, the out-of-core region including:
an inner reflector adjacent to the inner-core region, the inner reflector configured to increase the neutron flux, and
an outer reflector adjacent to the inner reflector, the outer reflector configured to reflect a neutron into the inner reflector; and
an auxiliary power system configured to support the nuclear reactor.

9. The nuclear reactor according to claim 8, wherein the inner-core region includes a moderator/coolant that contains calcium.

10. The nuclear reactor according to claim 9, wherein reactor power is regulated by a concentration of hydrogen gas within the inner-core region.

11. The nuclear reactor according to claim 8, wherein the inner reflector includes beryllium.

12. The nuclear reactor according to claim 8, wherein the outer reflector includes magnesium.

13. The nuclear reactor according to claim 8, wherein the nuclear reactor further includes uranium enriched below 20%.

14. The nuclear reactor according to claim 8, wherein the inner reflector includes a first irradiation facility, the first irradiation facility including a first flux trap and a second flux trap, wherein the first flux trap has a greater diameter than the second flux trap.

15. A system for producing medical isotopes, comprising:
a microreactor, including:
an inner-core region including:
a liquid uranium alloy fuel,
a moderator/coolant including calcium,
a hydrogen vapor space configured to receive hydrogen gas, and a fission product removal system; and
an out-of-core region surrounding the inner-core region, the out-of-core region including:
an inner reflector adjacent to the inner-core region, the inner reflector including a first irradiation facility, and
an outer reflector adjacent to the inner reflector, the outer reflector including a second irradiation facility.

16. The system for producing medical isotopes according to claim 15, wherein microreactor power is regulated by a concentration of hydrogen within the hydrogen vapor space.

17. The system for producing medical isotopes according to claim 15, wherein the inner reflector includes beryllium.

18. The system for producing medical isotopes according to claim 15, wherein the outer reflector includes magnesium oxide.

19. The system for producing medical isotopes according to claim 15, the out-of-core region further including a beam port and a rapid-transfer pneumatically accessed irradiation location.

20. The system for producing medical isotopes according to claim 15, wherein the first irradiation facility includes a first flux trap and a second flux trap, wherein the first flux trap has a greater diameter than the second flux trap.
